(19) United States
(12) Patent Application Publication
(10) Pub. No.: US 2024/0147440 A1
(43) Pub. Date: May 2, 2024

(54) METHODS AND APPARATUS FOR UL TX SWITCHING OF MULTIPLE TX CASES

(71) Applicant: QUALCOMM Incorporated, San Diego, CA (US)

(72) Inventors: Peter GAAL, San Diego, CA (US); Yiqing CAO, Beijing (CN); Alberto RICO ALVARINO, San Diego, CA (US); Kazuki TAKEDA, Minato-ku (JP)

(21) Appl. No.: 18/277,767

(22) PCT Filed: Apr. 17, 2021
(86) PCT No.: PCT/CN2021/087941

§ 371 Date: Aug. 17, 2023

(51) Int. Cl. H04W 72/0453; H04L 5/00; H04W 72/563

(52) U.S. Cl. CPC H04W 72/0453; H04L 5/001; H04W 72/563

(57) ABSTRACT

The present disclosure relates to methods and devices for wireless communication including an apparatus, e.g., a UE and/or base station. The apparatus may determine an UL Tx switching procedure including a plurality of switching cases, the UL Tx switching procedure associated with one or more Tx chains and/or one or more antenna ports, at least one of the one or more Tx chains or the one or more antenna ports corresponding to one or more CCs. The apparatus may also configure at least one of the one or more Tx chains or the one or more antenna ports associated with a target switching case of the plurality of switching cases. Further, the apparatus may transmit at least one UL transmission based on the configured at least one of the one or more Tx chains or the one or more antenna ports associated with the target switching case.

### BACKGROUND

### Technical Field

The present disclosure relates generally to communication systems, and more particularly, to uplink (UL) transmission (Tx) switching procedures.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive, from a base station, an indication of an uplink (UL) transmission (Tx) switching procedure, where the indication of the UL Tx switching procedure indicates a target switching case of a plurality of switching cases. The apparatus may also determine an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs). Additionally, the apparatus may switch, based on the determined UL Tx switching procedure, to the target switching case from one of the plurality of switching cases. The apparatus may also configure, based on the determined UL Tx switching procedure, at least one of the one or more Tx chains or the one or more antenna ports associated with a target switching case of the plurality of switching cases. The apparatus may also transmit, to a base station, at least one UL transmission based on the configured at least one of the one or more Tx chains or the one or more antenna ports associated with the target switching case.

In another aspect of the disclosure, a method, a computer-readable medium, and an apparatus are provided. The apparatus may be a base station. The apparatus may transmit, to a user equipment (UE), an indication of an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs). The apparatus may also receive, from the UE, at least one UL transmission based on at least one of the one or more Tx chains or the one or more antenna ports associated with a target switching case of the one of the plurality of switching cases.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is a diagram illustrating an example UL Tx switching procedure in accordance with one or more techniques of the present disclosure.

FIG. 4B is a diagram illustrating an example UL Tx switching procedure in accordance with one or more techniques of the present disclosure.

FIG. 5 is a diagram illustrating an example UL Tx switching procedure in accordance with one or more techniques of the present disclosure.

FIG. 6 is a diagram illustrating an example UL Tx switching procedure in accordance with one or more techniques of the present disclosure.

FIG. 7A is a diagram illustrating an example indication for an UL Tx switching procedure in accordance with one or more techniques of the present disclosure.

FIG. 7B is a diagram illustrating an example indication for an UL Tx switching procedure in accordance with one or more techniques of the present disclosure.

FIG. 8 is a diagram illustrating example specifications for UL Tx switching procedures in accordance with one or more techniques of the present disclosure.

FIG. 9 is a diagram illustrating example communication between a UE and a base station in accordance with one or more techniques of the present disclosure.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an example apparatus.

FIG. 14 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

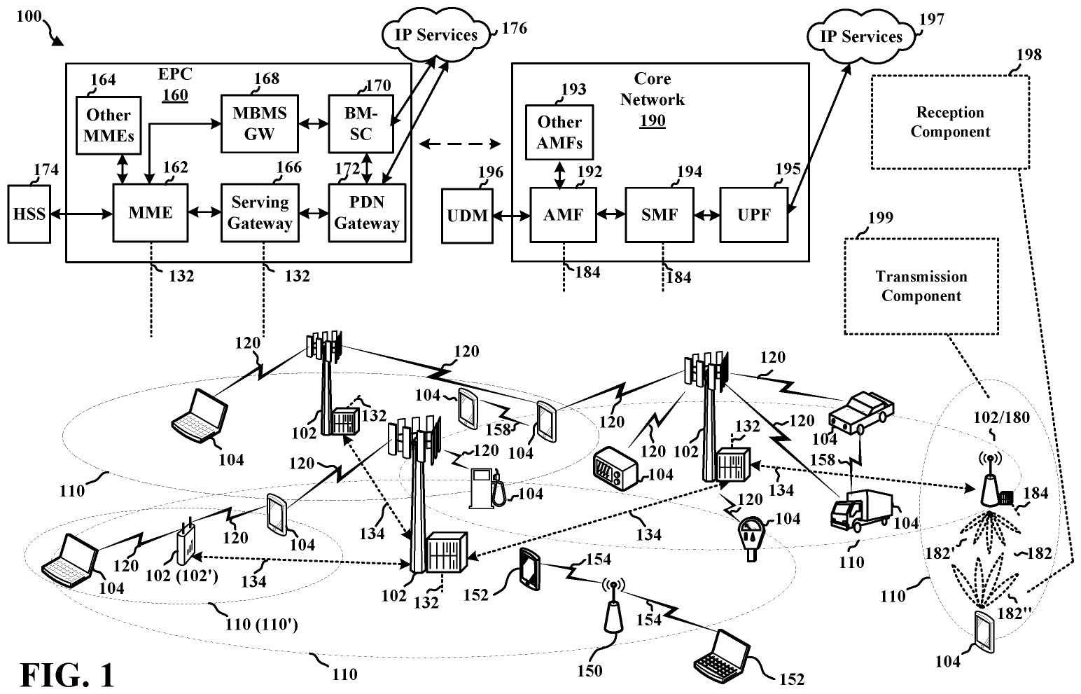

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a reception component 198 configured to receive, from a base station, an indication of an uplink (UL) transmission (Tx) switching procedure, where the indication of the UL Tx switching procedure indicates a target switching case of a plurality of switching cases. Reception component 198 may also be configured to determine an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs). Reception component 198 may also be configured to switch, based on the determined UL Tx switching procedure, to the target switching case from one of the plurality of switching cases. Reception component 198 may also be configured to configure, based on the determined UL Tx switching procedure, at least one of the one or more Tx chains or the one or more antenna ports associated with a target switching case of the plurality of switching cases. Reception component 198 may also be configured to transmit, to a base station, at least one UL transmission based on the configured at least one of the one or more Tx chains or the one or more antenna ports associated with the target switching case.

Referring again to FIG. 1, in certain aspects, the base station 180 may include a transmission component 199 configured to transmit, to a user equipment (UE), an indication of an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs). Transmission component 199 may also be configured to receive, from the UE, at least one UL transmission based on at least one of the one or more Tx chains or the one or more antenna ports associated with a target switching case of the one of the plurality of switching cases.

Although the following description may be focused on 5G NR, the concepts described herein may be applicable to other similar areas, such as LTE, LTE-A, CDMA, GSM, and other wireless technologies.

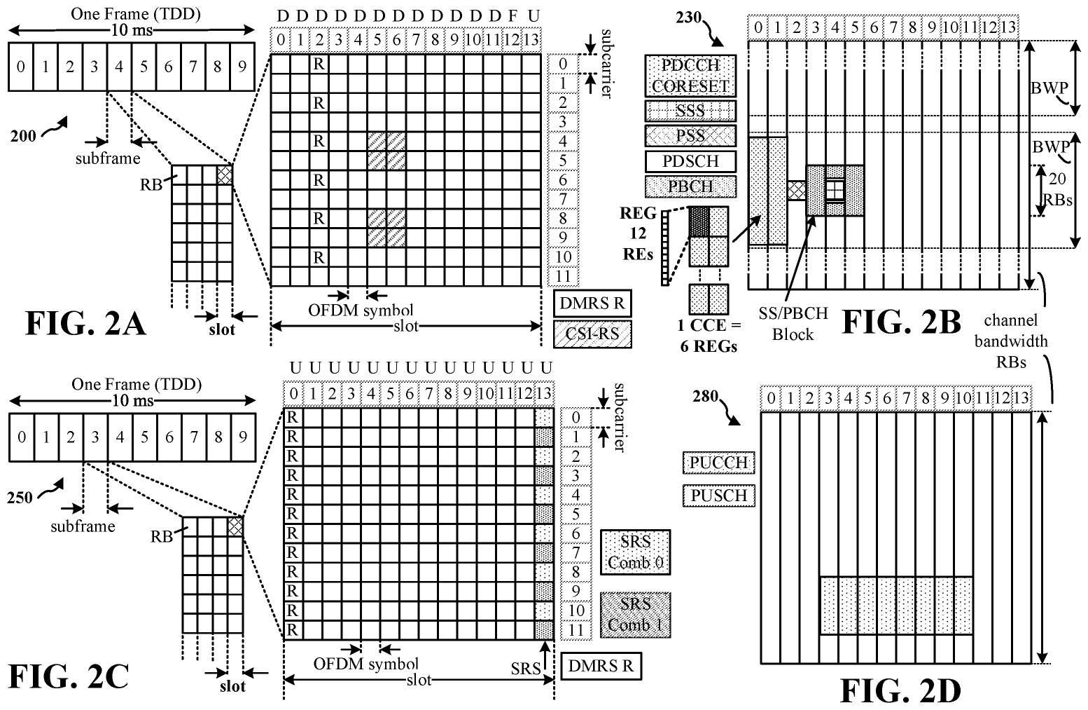

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on whether the cyclic prefix (CP) is normal or extended. For normal CP, each slot may include 14 symbols, and for extended CP, each slot may include 7 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

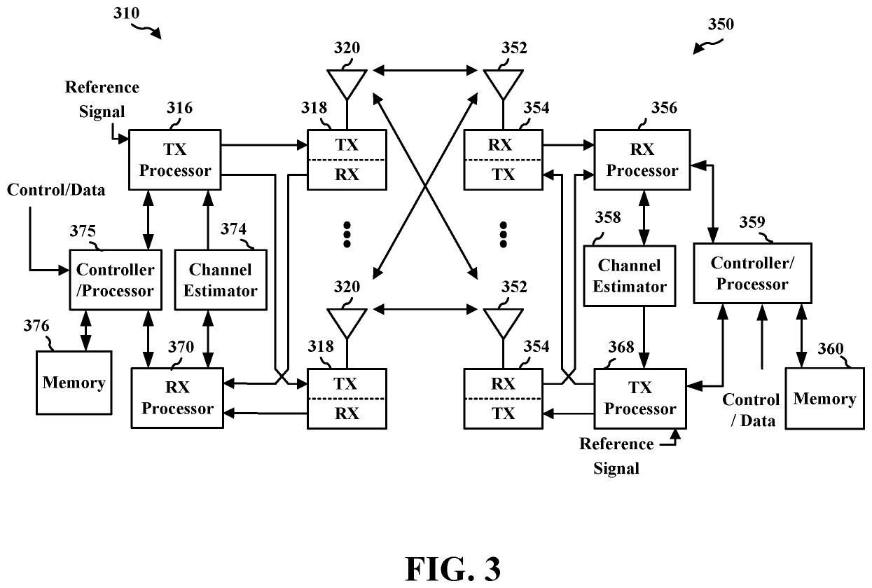

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer ofupper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

Some aspects of wireless communication utilize procedures to switch uplink (UL) transmissions, i.e., UL transmission (Tx) switching procedures. In some instances, there may be certain specifications that indicate for UEs to enable UL Tx switching in difference scenarios. For instance, certain specifications may indicate for UEs to enable UL Tx switching between different switching cases across component carriers based on supplementary uplink (SUL) and/or new radio (NR) inter-band uplink carrier aggregation (CA). These types of specifications may be indicated for certain types of UEs, e.g., UEs supporting a maximum of two concurrent transmissions. Some types of UL Tx switching scenarios may also minimize an impact on certain radio access networks (RANs), e.g., RANi. For instance, certain types of uplink switching, e.g., RANi uplink switching, may be updated for carrier aggregation and supplementary uplink scenarios.

In some aspects, for UL Tx switching based on a supplementary uplink (SUL) band combination and/or an uplink CA band combination, a number of Tx chains may be specified for certain switching cases, e.g., a first switching case (case 1), a second switching case (case 2), or a third switching case (case 3). The number of Tx chains may also be associated with different component carriers (CCs), e.g., a first CC (CC1) or a second CC (CC2). For example, for a second switching case (case 2), the number of Tx chains associated with CC1 may be zero (0) and the number of Tx chains associated with CC2 may be two (2). Also, for a third switching case (case 3), the number of Tx chains associated with CC1 may be two (2) and the number of Tx chains associated with CC2 may be zero (0). Additionally, for UL Tx switching based on an uplink CA band combination, a number of Tx chains may be specified for certain switching cases. For a first switching case (case 1), the number of Tx chains associated with CC1 may be one (1) and the number of Tx chains associated with CC2 may be one (1). For a second switching case (case 2), the number of Tx chains associated with CC1 may be zero (0) and the number of Tx chains associated with CC2 may be two (2). For a third switching case (case 3), the number of Tx chains associated with CC1 may be two (2) and the number of Tx chains associated with CC2 may be zero (0).

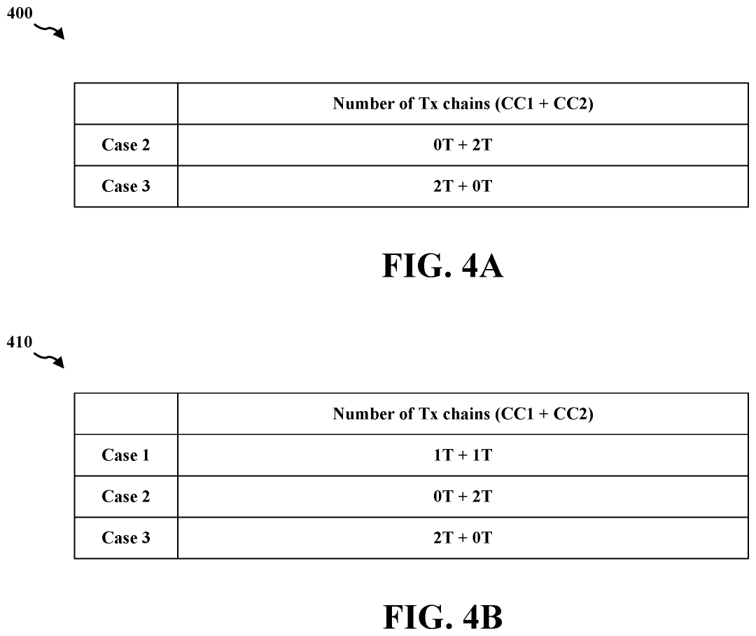

FIGS. 4A and 4B are diagrams 400 and 410, respectively, of example UL Tx switching procedures. As shown in FIG. 4A, diagram 400 is an example of UL Tx switching based on a SUL band combination and/or an uplink CA band combination. Diagram 400 depicts that for a second switching case (case 2), the number of Tx chains (T) associated with CC1 is zero (0) and the number of Tx chains associated with CC2 is two (2), i.e., 0T+2T. For a third switching case (case 3), the number of Tx chains (T) associated with CC1 is two (2) and the number of Tx chains associated with CC2 is zero (0), i.e., 2T+0T.

As shown in FIG. 4B, diagram 410 is an example of UL Tx switching based on an uplink CA band combination. Diagram 410 depicts that for a first switching case (case 1), the number of Tx chains (T) associated with CC1 is one (1) and the number of Tx chains associated with CC2 is one (1), i.e., 1T+1T. For a second switching case (case 2), the number of Tx chains (T) associated with CC1 is zero (0) and the number of Tx chains associated with CC2 is two (2), i.e., 0T+2T. Also, for a third switching case (case 3), the number of Tx chains (T) associated with CC1 is two (2) and the number of Tx chains associated with CC2 is zero (0), i.e., 2T+0T.

In some instances, certain specifications may indicate for UEs to enable UL Tx switching between different switching cases where one component carrier is on a certain frequency band, e.g., band A, and multiple contiguous aggregated component carriers are on another frequency band, e.g., band B. Also, some frequency bands may be a SUL band or a non-SUL band, e.g., band A may be a SUL band and band B may be a non-SUL band. For UL Tx switching based on a SUL band combination and/or an uplink CA band combination, a number of Tx chains may be specified for certain switching cases, e.g., a first switching case (case 1), a second switching case (case 2), or a third switching case (case 3), and may be associated with different frequency bands, e.g., band A or band B. For example, for a first switching case (case 1), the number of Tx chains associated with band A may be one (1) and the number of Tx chains associated with band B may be one (1). For a second switching case (case 2), the number of Tx chains associated with band A may be zero (0) and the number of Tx chains associated with band B may be two (2). For a third switching case (case 3), the number of Tx chains associated with band A may be two (2) and the number of Tx chains associated with band B may be zero (0).

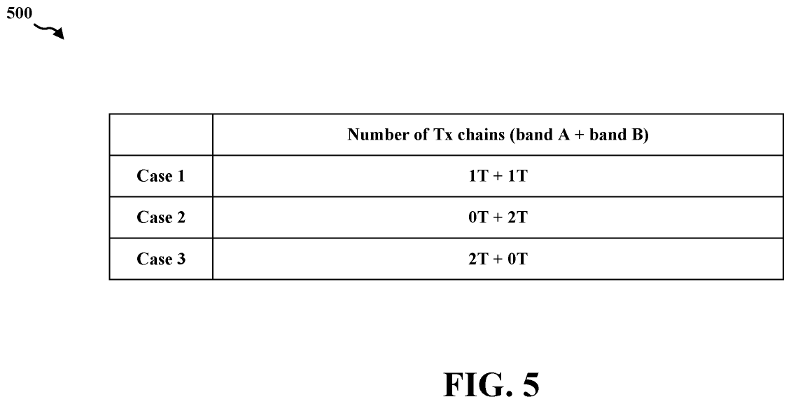

FIG. 5 is a diagram 500 of an example UL Tx switching procedure. As shown in FIG. 5, diagram 500 is an example of UL Tx switching based on a SUL band combination and/or an uplink CA band combination for certain switching cases and different frequency bands. Diagram 500 depicts that for a first switching case (case 1), the number of Tx chains (T) associated with band A is one (1) and the number of Tx chains associated with band B is one (1), i.e., 1T+1T. For a second switching case (case 2), the number of Tx chains (T) associated with band A is zero (0) and the number of Tx chains associated with band B is two (2), i.e., 0T+2T. Moreover, for a third switching case (case 3), the number of Tx chains (T) associated with band A is two (2) and the number of Tx chains associated with band B is zero (0), i.e., 2T+0T.

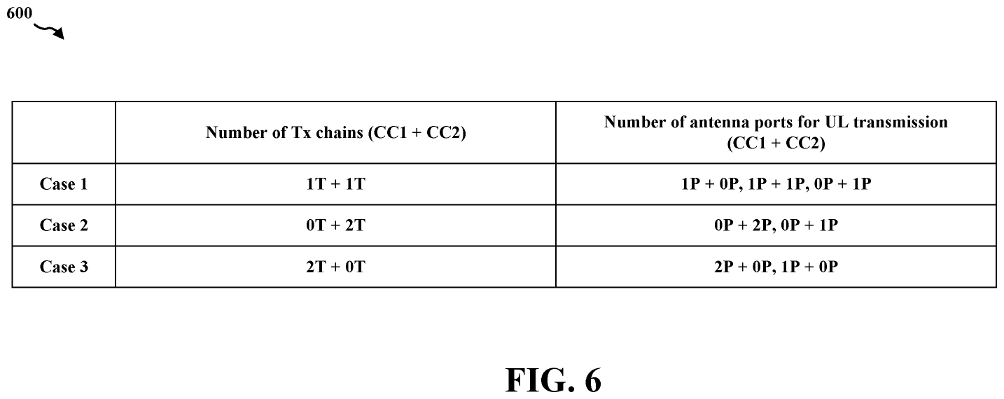

Some aspects of wireless communications may specify multiple Tx UL switching, e.g., two (2) Tx UL switching, between multiple CCs, e.g., two (2) CCs. For certain UL CA options, e.g., UL CA option 2 (i.e., simultaneous Tx of 2 CCs is allowed), a memory-based mapping rule may be utilized between Tx chains and antenna ports. FIG. 6 is a diagram 600 of an example UL Tx switching procedure. As shown in FIG. 6, diagram 600 is an example of UL Tx switching based on UL CA option 2 (i.e., simultaneous Tx of 2 CCs is allowed) including a memory-based mapping rule between Tx chains and antenna ports. Diagram 600 depicts that for a first switching case (case 1), the number of Tx chains (T) associated with CC1 is one (1) and the number of Tx chains associated with CC2 is one (1), i.e., 1T+1T. For a second switching case (case 2), the number of Tx chains (T) associated with CC1 is zero (0) and the number of Tx chains associated with CC2 is two (2), i.e., 0T+2T. Also, for a third switching case (case 3), the number of Tx chains (T) associated with CC1 is two (2) and the number of Tx chains associated with CC2 is zero (0), i.e., 2T+0T.

As shown in FIG. 6, diagram 600 also depicts a number of antenna ports (P) for UL transmission associated with certain component carriers, e.g., CC1 or CC2. For case 1, the number of antenna ports (P) associated with CC1 may be one (1) or zero (0) and the number of antenna ports (P) associated with CC2 may be one (1) or zero (0), i.e., 1P+0P, 1P+1P, or 0P+1P. For case 2, the number of antenna ports (P) associated with CC1 may be zero (0) and the number of antenna ports (P) associated with CC2 may be one (1) or two (2), i.e., 0P+2P or 0P+1P. For case 3, the number of antenna ports (P) associated with CC1 may be two (2) or one (1) and the number of antenna ports (P) associated with CC2 may be zero (0), i.e., 2P+0P or 1P+0P.

Some aspects of wireless communications may be associated with two switching cases, e.g., case 1 and case 2. In these aspects, the network or base station may implicitly trigger the switching between different cases, e.g., via DCI scheduling or RRC signaling/configuration. Other aspects of wireless communications may be associated with other switching cases, e.g., case 3. In these aspects, the number of antenna ports (P) may be mapped to certain switching cases, e.g., 0P+1P and 1P+0P may map to the cases shown in FIG. 6 above.

In some aspects, a UE may need to switch to a certain component carrier for a certain number of antenna ports (P), but it may not be able to determine a target switching case. For example, if a UE is utilizing case 3 and wants to switch to 0P+1P, the UE may not be able to determine the target switching case, as both case 1 and 2 may allow for a certain number of antenna ports (P), e.g., 0P+1P. Similarly, if a UE is utilizing case 2 and wants to switch to 1P+0P, the UE may not be able to determine the target switching case. Based on the above, it may be beneficial for UEs to be able to determine a target switching case out of multiple switching cases. It may also be beneficial for a base station/network to indicate a target switching case to a UE. Further, it may be beneficial to predefine certain mapping rules for target switching cases, i.e., without any signaling or indication.

Aspects of the present disclosure may allow UEs to be able to determine a target switching case from multiple switching cases. For instance, aspects of the present disclosure may allow UEs to configure Tx chains and/or antenna ports associated with a target switching case. Aspects of the present disclosure may also allow a base station or network to signal or indicate a target switching case to a UE, e.g., via RRC signaling. Moreover, aspects of the present disclosure may predefine or preconfigure certain mapping rules for target switching cases, i.e., without any signaling or indication.

In some aspects of the present disclosure, a target switching case may be signaled or indicated to a UE, such as via RRC signaling or an RRC configuration. An RRC configuration of the target switching case may be switched between multiple switching cases, e.g., two switching cases, such that the RRC configuration may be referred to as symmetric. In one example, an indication of a certain switching case, e.g., case 3, followed by a certain number of antenna ports (P), e.g., 0P+1P, may imply a switch to another case, e.g., case 1. Further, in this example, an indication of case 2 followed by an antenna port configuration of 1P+0P may imply switching to case 1. In another example, an indication of case 3 followed by an antenna port configuration of 0P+1P may imply switching to case 2. Also, in this example, an indication of case 2 followed by an antenna port configuration of 1P+0P may imply a switch to case 2.

Additionally, RRC signaling/configuration of the target switching case may be switched between multiple switching cases, e.g., four cases, such that the RRC configuration may be referred to as asymmetric. In these instances, the indication or RRC configuration may include multiple component parts or multiple bits. For example, if a first bit of the indication switches between case 3 followed by an antenna port configuration of 0P+1P, this may imply a switch to case 1. Also, if a first bit of the indication switches between case 3 followed by an antenna port configuration of 0P+1P, this may imply a switch to case 2. If a second bit of the indication switches between case 2 followed by an antenna port configuration of 1P+0P, this may imply a switch to case 1. Moreover, if a second bit of the indication switches between case 2 followed by an antenna port configuration of 1P+0P, this may imply a switch to case 3.

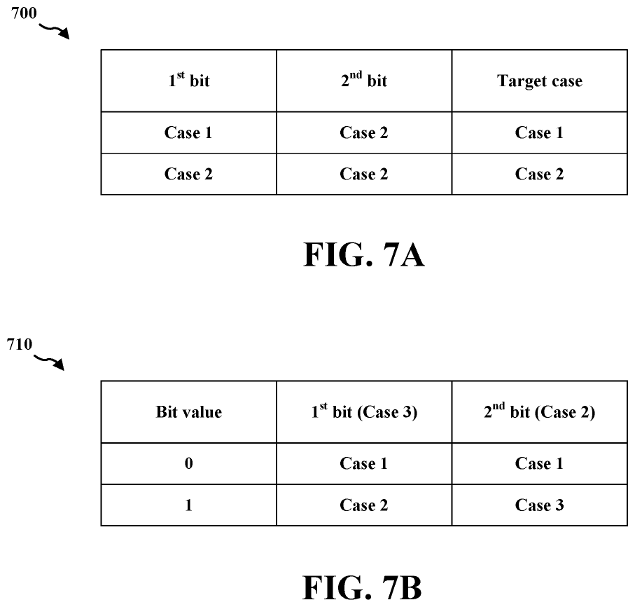

FIGS. 7A and 7B are diagrams 700 and 710, respectively, of example indications or signaling for UL Tx switching procedures according to the present disclosure. As shown in FIG. 7A, diagram 700 is an example indication of UL Tx switching for symmetric RRC configurations. Diagram 700 depicts that if a first bit in the indication corresponds to case 1 and a second bit in the indication corresponds to case 2, the target switching case may correspond to case 1. Also, diagram 700 depicts that if a first bit in the indication corresponds to case 2 and a second bit in the indication corresponds to case 2, the target switching case may correspond to case 2.

As shown in FIG. 7B, diagram 710 is an example indication of UL Tx switching for asymmetric RRC configurations. Diagram 710 depicts that if a first bit of the indication is zero (0) and switches between case 3 followed by an antenna port configuration of 0P+1P, this may imply a switch to case 1. If a first bit of the indication is one (1) and switches between case 3 followed by an antenna port configuration of 0P+1P, this may imply a switch to case 2. As further shown in diagram 710, if a second bit of the indication is zero (0) and switches between case 2 followed by an antenna port configuration of 1P+0P, this may imply a switch to case 1. Further, if a second bit of the indication is one (1) and switches between case 2 followed by an antenna port configuration of 1P+0P, this may imply a switch to case 3.

In yet another aspect of the present disclosure, there may be an indication or signal regarding which of the CCs is prioritized. If a CC is prioritized, a UE may select the state with a maximum number of ports in the prioritized carrier. For example, if CC1 is prioritized, case 3 and an antenna port configuration of 0P+1P may imply a switch to case 1. If CC2 is prioritized, case 3 and an antenna port configuration of 0P+1P may imply a switch to case 2.

In some aspects of the present disclosure, a target switching case may be predetermined, predefined, or preconfigured for the UE, e.g., via a specification. Accordingly, there may be no signaling or indication of the target switching case. In these instances, aspects of the present disclosure may prioritize one switching case out of multiple switching cases if the case allows for a certain antenna port configuration. For example, aspects of the present disclosure may prioritize case 1 if it allows for an antenna port configuration of 1P+1P.

Additionally, aspects of the present disclosure may prioritize one CC if it is a primary component carrier (PCC). For example, if CC1 is a PCC, case 3 followed by an antenna port configuration of 0P+1P may imply a switch to case 1, and case 2 followed by an antenna port configuration of 1P+0P may imply a switch to case 3. If CC2 is a PCC, case 3 followed by an antenna port configuration of 0P+1P may imply a switch to case 2, and case 1 followed by an antenna port configuration of 1P+0P may imply a switch to case 3. If both CC1 and CC2 are secondary component carriers (SCCs), aspects of the present disclosure may prioritize case 1 if it allows for an antenna port configuration of 1P+1P.

Further, aspects of the present disclosure may define separate mapping rules for sub-cases in certain switching cases, e.g., two sub-cases in case 3 and case 2. For example, for a UE in case 3, an antenna port configuration of 2P+0P may imply a switch to case 2, and an antenna port configuration of 1P+0P may imply a switch to case 1. Also, for a UE in case 2, an antenna port configuration of 0P+2P may imply a switch to case 3, and an antenna port configuration of 0P+1P may imply a switch to case 1.

In some aspects, if CC1 is a PCC, case 3 followed by an antenna port configuration of 0P+1P may imply a switch to case 1. If CC1 is a PCC, case 2 followed by an antenna port configuration of 1P+0P may imply that if a last transmission was 0P+2P, then switch to case 3. Also, if CC1 is a PCC, case 2 followed by an antenna port configuration of 1P+0P may imply that if a last transmission was 0P+1P, then switch to case 1. If CC2 is a PCC, case 1 followed by an antenna port configuration of 1P+0P may imply that if a last transmission was 0P+2P, then switch to case 3. Further, if CC2 is a PCC, case 1 followed by an antenna port configuration of 1P+0P may imply that if a last transmission was 0P+1P, then switch to case 2. If both CC1 and CC2 are SCCs, for a UE in case 3, an antenna port configuration of 2P+0P may imply a switch to case 2, and an antenna port configuration of 1P+0P may imply a switch to case 1. Moreover, if both CC1 and CC2 are SCCs, for a UE in case 2, an antenna port configuration of 0P+2P may imply a switch to case 3, and an antenna port configuration of 0P+1P may imply a switch to case 1.

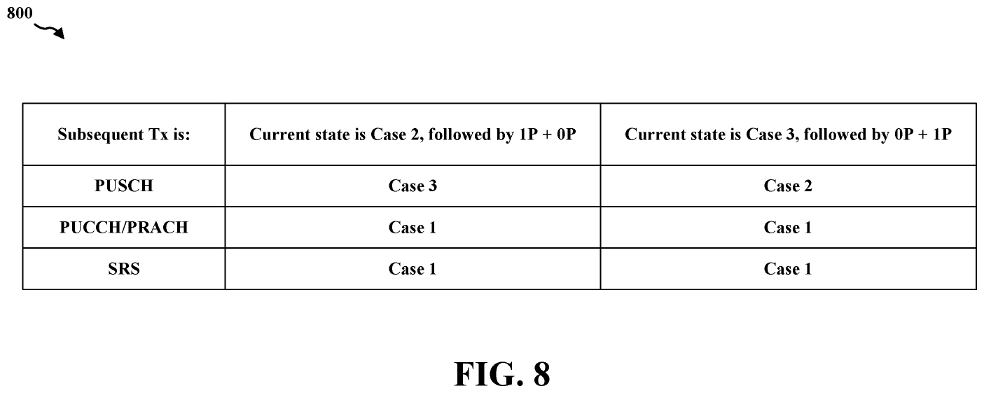

FIG. 8 is a diagram 800 of example specifications for UL Tx switching procedures. As shown in FIG. 8, diagram 800 depicts that if a subsequent transmission is a PUSCH and a current switching state is case 2, an antenna port configuration of IP+0P may imply a switch to case 3. As further shown in FIG. 8, if a subsequent transmission is a PUSCH and a current switching state is case 3, an antenna port configuration of 0P+1P may imply a switch to case 2. Additionally, if a subsequent transmission is a PUCCH/physical random access channel (PRACH) and a current switching state is case 2, an antenna port configuration of 1P+0P may imply a switch to case 1. If a subsequent transmission is a PUCCH/PRACH and a current switching state is case 3, an antenna port configuration of 0P+1P may imply a switch to case 1. Further, if a subsequent transmission is an SRS and a current switching state is case 2, an antenna port configuration of 1P+0P may imply a switch to case 1. If a subsequent transmission is an SRS and a current switching state is case 3, an antenna port configuration of 0P+1P may imply a switch to case 1.

In some aspects, UL Tx switching procedures may depend on a frame structure. For instance, UL Tx switching procedures may depend on whether CC1 is associated with time division duplexing (TDD) or frequency division duplexing (FDD), while CC2 is associated with TDD. If CC1 is associated with FDD, a UE may prioritize CC1, then there may be an indication of which of the CCs is prioritized, e.g., UE may select the state with maximum number of ports in the prioritized carrier. If CC1 is associated with TDD, a UE may prioritize the CC with more UL transmissions in a number of subsequent slots.

Aspects of the present disclosure may include a number of benefits or advantages. For instance, aspects of the present disclosure may allow UEs to easily determine a target switching case from multiple switching cases. By doing so, aspects of the present disclosure may increase the accuracy of UL Tx switching procedures. Further, aspects of the present disclosure may reduce the amount of power utilized at UEs during UL Tx switching procedures.

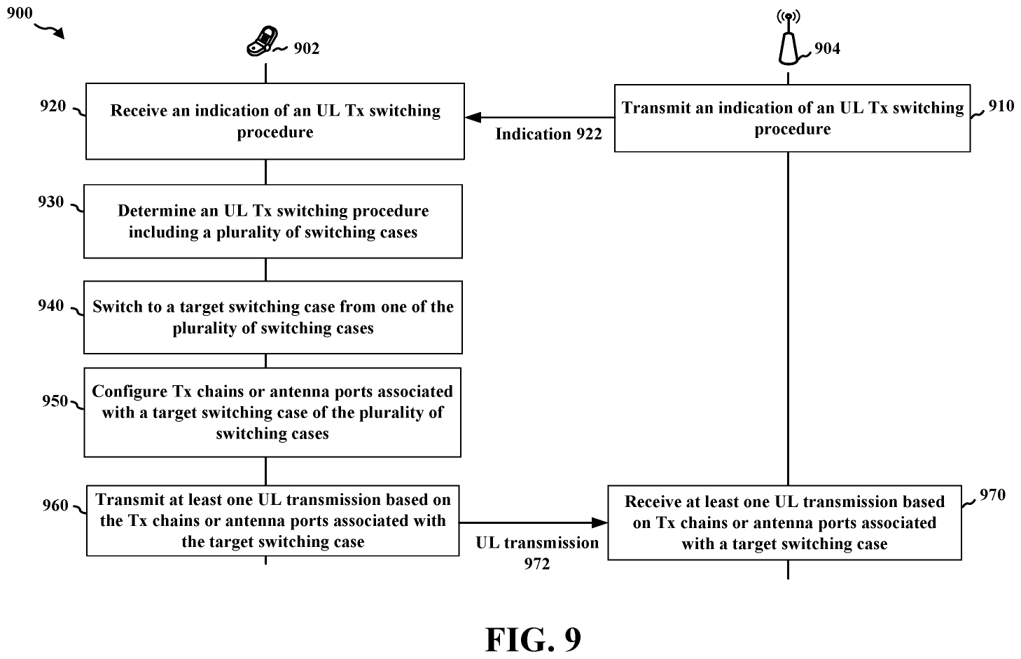

FIG. 9 is a diagram 900 illustrating example communication between a UE 902 and a base station 904. At 910, base station 904 may transmit, to a user equipment (UE), an indication of an uplink (UL) transmission (Tx) switching procedure including a plurality of switching cases, e.g., indication 922, the UL Tx switching procedure associated with at least one of one or more Tx chains or one or more antenna ports, at least one of the one or more Tx chains or the one or more antenna ports corresponding to one or more component carriers (CCs).

At 920, UE 902 may receive, from a base station, an indication of an uplink (UL) transmission (Tx) switching procedure, e.g., indication 922, where the indication of the UL Tx switching procedure indicates a target switching case of a plurality of switching cases. The indication of the UL Tx switching procedure may be received via radio resource control (RRC) signaling. The indication of the UL Tx switching procedure may be associated with multiple component parts, each of the multiple component parts being associated with one of the plurality of switching cases. Further, the indication of the UL Tx switching procedure may be associated with multiple component parts, each of the multiple component parts being associated with two of the plurality of switching cases. The indication of the UL Tx switching procedure may indicate that one of the one or more CCs is a priority CC.

At 930, UE 902 may determine an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs).

In some aspects, the UL Tx switching procedure including the plurality of switching cases may be predetermined, predefined, or preconfigured. Also, one of the plurality of switching cases may be a priority switching case. One CC of the one or more CCs may be a primary component carrier (PCC) and another CC of the one or more CCs may be a secondary component carrier (SCC), the one CC being a priority CC. At least one of the plurality of switching cases may be mapped to at least one of the one or more antenna ports, where the one or more antenna ports may correspond to one or more antenna port combinations configured for each of the one or more CCs. Also, the plurality of switching cases may be mapped to the one or more antenna ports based on a physical channel or signal of the at least one UL transmission, where the one or more antenna ports may correspond to one or more antenna port combinations configured for each of the one or more CCs.

Additionally, the plurality of switching cases may include at least one of a first case (case 1), a second case (case 2), or a third case (case 3). The one or more CCs may include a first CC and a second CC. If a first CC of the one or more CCs is associated with frequency division duplexing (FDD), the first CC may be a priority CC. If the first CC is associated with time division duplexing (TDD), the priority CC may be one of the one or more CCs with a greater amount of UL transmissions.

At 940, UE 902 may switch, based on the determined UL Tx switching procedure, to the target switching case from one of the plurality of switching cases.

At 950, UE 902 may configure, based on the determined UL Tx switching procedure, at least one of the one or more Tx chains or the one or more antenna ports associated with a target switching case of the plurality of switching cases.

At 960, UE 902 may transmit, to a base station, at least one UL transmission, e.g., UL transmission 972, based on the configured at least one of the one or more Tx chains or the one or more antenna ports associated with the target switching case.

At 970, base station 904 may receive, from the UE, at least one UL transmission, e.g., UL transmission 972, based on at least one of the one or more Tx chains or the one or more antenna ports associated with a target switching case of the one of the plurality of switching cases.

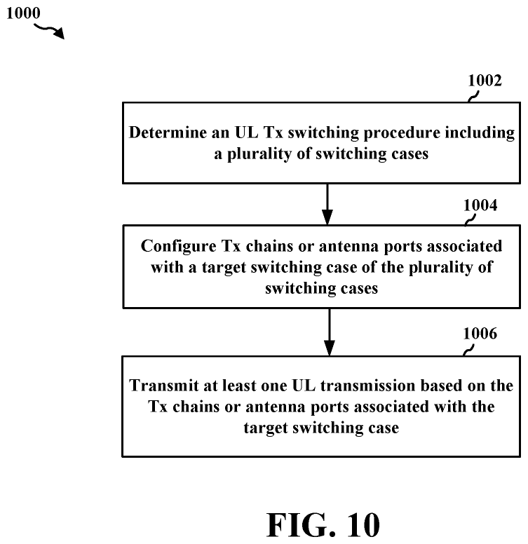

FIG. 10 is a flowchart 1000 of a method of wireless communication. The method may be performed by a UE or a component of a UE (e.g., the UE 104, 350, 902; apparatus 1302). The methods described herein can provide a number of benefits, such as improving communication signaling, resource utilization, and/or power savings.

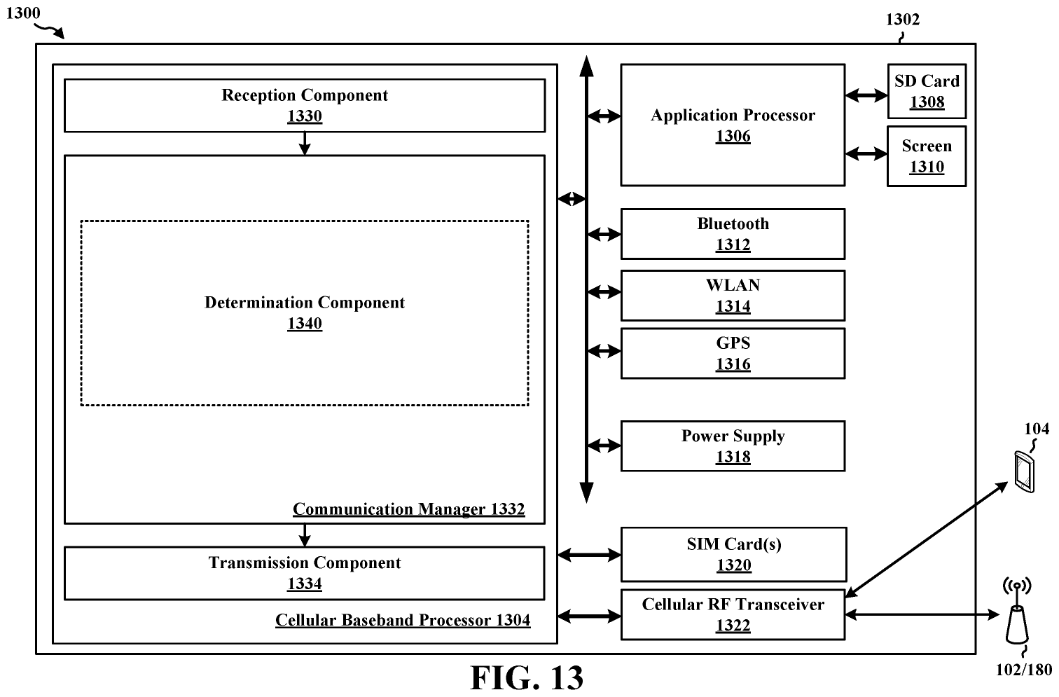

At 1002, the apparatus may determine an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs), as described in connection with the examples in FIGS. 4A-9. For example, UE 902 may determine an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs), as described in connection with 930 in FIG. 9. Further, 1002 may be performed by determination component 1340 in FIG. 13.

In some aspects, the UL Tx switching procedure including the plurality of switching cases may be predetermined, predefined, or preconfigured. Also, one of the plurality of switching cases may be a priority switching case. One CC of the one or more CCs may be a primary component carrier (PCC) and another CC of the one or more CCs may be a secondary component carrier (SCC), the one CC being a priority CC. At least one of the plurality of switching cases may be mapped to at least one of the one or more antenna ports, where the one or more antenna ports may correspond to one or more antenna port combinations configured for each of the one or more CCs. Also, the plurality of switching cases may be mapped to the one or more antenna ports based on a physical channel or signal of the at least one UL transmission, where the one or more antenna ports may correspond to one or more antenna port combinations configured for each of the one or more CCs.

Further, the plurality of switching cases may include at least one of a first case (case 1), a second case (case 2), or a third case (case 3). The one or more CCs may include a first CC and a second CC. If a first CC of the one or more CCs is associated with frequency division duplexing (FDD), the first CC may be a priority CC. If the first CC is associated with time division duplexing (TDD), the priority CC may be one of the one or more CCs with a greater amount of UL transmissions.

At 1004, the apparatus may configure, based on the determined UL Tx switching procedure, at least one of the one or more Tx chains or the one or more antenna ports associated with a target switching case of the plurality of switching cases, as described in connection with the examples in FIGS. 4A-9. For example, UE 902 may configure, based on the determined UL Tx switching procedure, at least one of the one or more Tx chains or the one or more antenna ports associated with a target switching case of the plurality of switching cases, as described in connection with 950 in FIG. 9. Further, 1004 may be performed by determination component 1340 in FIG. 13.

At 1006, the apparatus may transmit, to a base station, at least one UL transmission based on the configured at least one of the one or more Tx chains or the one or more antenna ports associated with the target switching case, as described in connection with the examples in FIGS. 4A-9. For example, UE 902 may transmit, to a base station, at least one UL transmission based on the configured at least one of the one or more Tx chains or the one or more antenna ports associated with the target switching case, as described in connection with 960 in FIG. 9. Further, 1006 may be performed by determination component 1340 in FIG. 13.

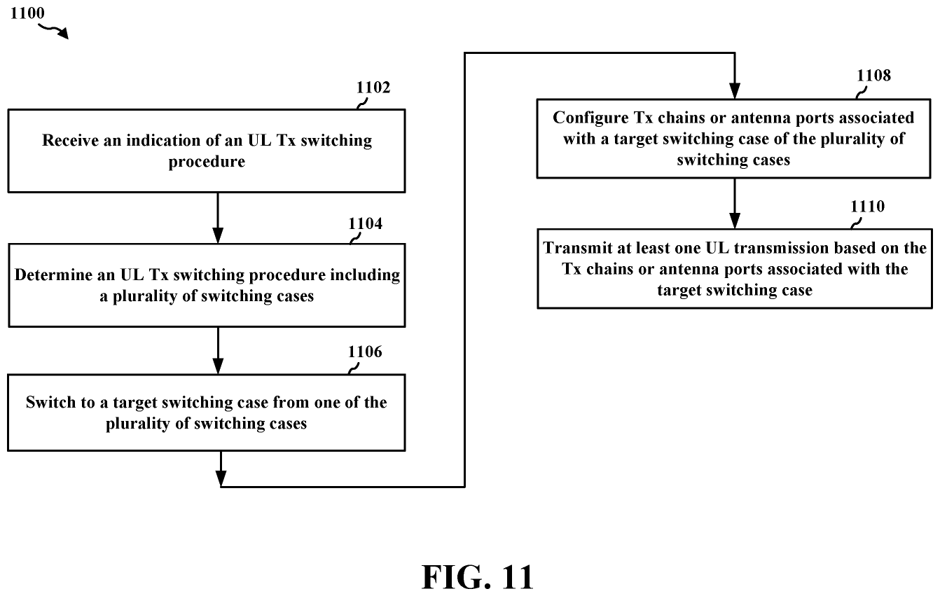

FIG. 11 is a flowchart 1100 of a method of wireless communication. The method may be performed by a UE or a component of a UE (e.g., the UE 104, 350, 902; apparatus 1302). The methods described herein can provide a number of benefits, such as improving communication signaling, resource utilization, and/or power savings.

At 1102, the apparatus may receive, from a base station, an indication of an uplink (UL) transmission (Tx) switching procedure, where the indication of the UL Tx switching procedure indicates a target switching case of a plurality of switching cases, as described in connection with the examples in FIGS. 4A-9. For example, UE 902 may receive, from a base station, an indication of an uplink (UL) transmission (Tx) switching procedure, where the indication of the UL Tx switching procedure indicates a target switching case of a plurality of switching cases, as described in connection with 920 in FIG. 9. Further, 1102 may be performed by determination component 1340 in FIG. 13.

In some instances, the indication of the UL Tx switching procedure may be received via radio resource control (RRC) signaling. The indication of the UL Tx switching procedure may be associated with multiple component parts, each of the multiple component parts being associated with one of the plurality of switching cases. Further, the indication of the UL Tx switching procedure may be associated with multiple component parts, each of the multiple component parts being associated with two of the plurality of switching cases. The indication of the UL Tx switching procedure may indicate that one of the one or more CCs is a priority CC.

At 1104, the apparatus may determine an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs), as described in connection with the examples in FIGS. 4A-9. For example, UE 902 may determine an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs), as described in connection with 930 in FIG. 9. Further, 1104 may be performed by determination component 1340 in FIG. 13.

In some aspects, the UL Tx switching procedure including the plurality of switching cases may be predetermined, predefined, or preconfigured. Also, one of the plurality of switching cases may be a priority switching case. One CC of the one or more CCs may be a primary component carrier (PCC) and another CC of the one or more CCs may be a secondary component carrier (SCC), the one CC being a priority CC. At least one of the plurality of switching cases may be mapped to at least one of the one or more antenna ports, where the one or more antenna ports may correspond to one or more antenna port combinations configured for each of the one or more CCs. Also, the plurality of switching cases may be mapped to the one or more antenna ports based on a physical channel or signal of the at least one UL transmission, where the one or more antenna ports may correspond to one or more antenna port combinations configured for each of the one or more CCs.

Moreover, the plurality of switching cases may include at least one of a first case (case 1), a second case (case 2), or a third case (case 3). The one or more CCs may include a first CC and a second CC. If a first CC of the one or more CCs is associated with frequency division duplexing (FDD), the first CC may be a priority CC. If the first CC is associated with time division duplexing (TDD), the priority CC may be one of the one or more CCs with a greater amount of UL transmissions.

At 1106, the apparatus may switch, based on the determined UL Tx switching procedure, to the target switching case from one of the plurality of switching cases, as described in connection with the examples in FIGS. 4A-9. For example, UE 902 may switch, based on the determined UL Tx switching procedure, to the target switching case from one of the plurality of switching cases, as described in connection with 940 in FIG. 9. Further, 1106 may be performed by determination component 1340 in FIG. 13.

At 1108, the apparatus may configure, based on the determined UL Tx switching procedure, at least one of the one or more Tx chains or the one or more antenna ports associated with a target switching case of the plurality of switching cases, as described in connection with the examples in FIGS. 4A-9. For example, UE 902 may configure, based on the determined UL Tx switching procedure, at least one of the one or more Tx chains or the one or more antenna ports associated with a target switching case of the plurality of switching cases, as described in connection with 950 in FIG. 9. Further, 1108 may be performed by determination component 1340 in FIG. 13.

At 1110, the apparatus may transmit, to a base station, at least one UL transmission, e.g., UL transmission 972, based on the configured at least one of the one or more Tx chains or the one or more antenna ports associated with the target switching case, as described in connection with the examples in FIGS. 4A-9. For example, UE 902 may transmit, to a base station, at least one UL transmission, e.g., UL transmission 972, based on the configured at least one of the one or more Tx chains or the one or more antenna ports associated with the target switching case, as described in connection with 960 in FIG. 9. Further, 1110 may be performed by determination component 1340 in FIG. 13.

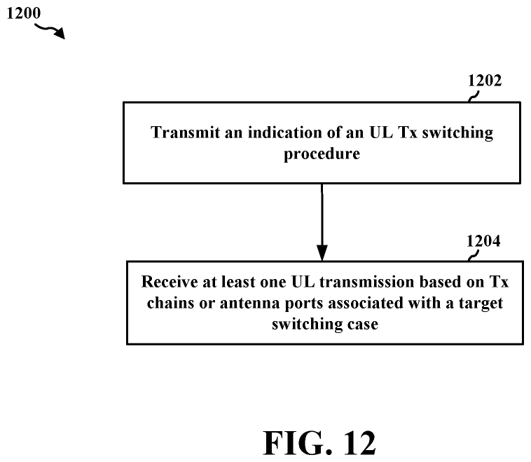

FIG. 12 is a flowchart 1200 of a method of wireless communication. The method may be performed by a base station or a component of a base station (e.g., the base station 102, 180, 310, 904; apparatus 1402). The methods described herein can provide a number of benefits, such as improving communication signaling, resource utilization, and/or power savings.

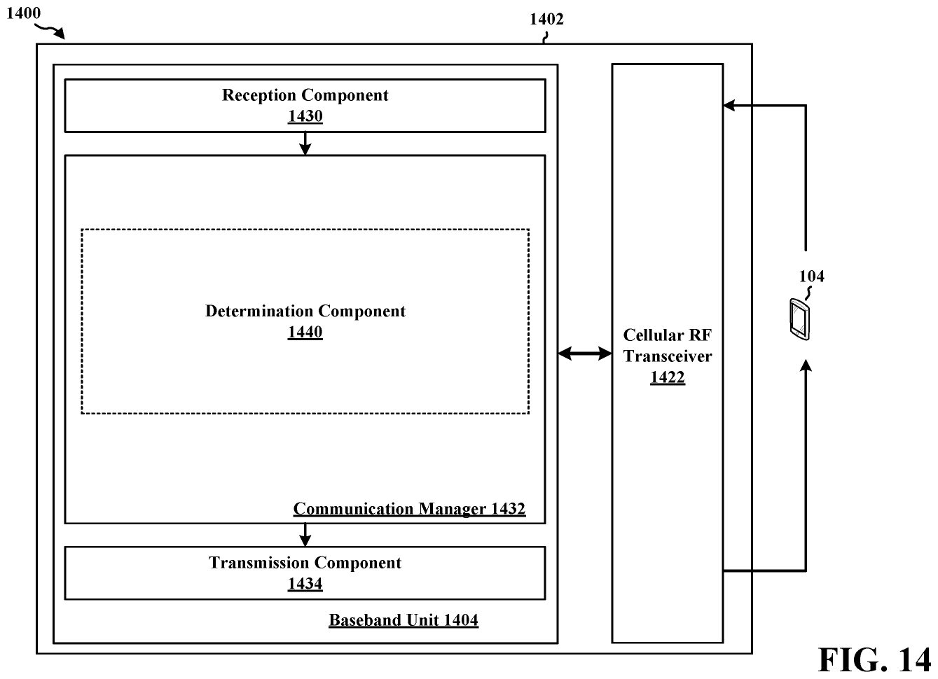

At 1202, the apparatus may transmit, to a user equipment (UE), an indication of an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs), as described in connection with the examples in FIGS. 4A-9. For example, base station 904 may transmit, to a user equipment (UE), an indication of an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs), as described in connection with 910 in FIG. 9. Further, 1202 may be performed by determination component 1440 in FIG. 14.

In some aspects, the indication of the UL Tx switching procedure may indicate the target switching case. The indication of the UL Tx switching procedure may be transmitted via radio resource control (RRC) signaling. The indication of the UL Tx switching procedure may be associated with multiple component parts, each of the multiple component parts being associated with one of the plurality of switching cases. The indication of the UL Tx switching procedure may be associated with multiple component parts, each of the multiple component parts being associated with two of the plurality of switching cases. The indication of the UL Tx switching procedure may indicate that one of the one or more CCs is a priority CC.

Additionally, the UL Tx switching procedure including the plurality of switching cases may be predetermined, predefined, or preconfigured. One of the plurality of switching cases may be a priority switching case. One CC of the one or more CCs may be a primary component carrier (PCC) and another CC of the one or more CCs may be a secondary component carrier (SCC), the one CC being a priority CC. Also, at least one of the plurality of switching cases may be mapped to at least one of the one or more antenna ports, where the one or more antenna ports may correspond to one or more antenna port combinations configured for each of the one or more CCs. The plurality of switching cases may also be mapped to the one or more antenna ports based on a physical channel or signal of the at least one UL transmission, where the one or more antenna ports may correspond to one or more antenna port combinations configured for each of the one or more CCs.

If a first CC of the one or more CCs is associated with frequency division duplexing (FDD), the first CC may be a priority CC. If the first CC is associated with time division duplexing (TDD), the priority CC may be one of the one or more CCs with a greater amount of UL transmissions. The plurality of switching cases may include at least one of a first case (case 1), a second case (case 2), or a third case (case 3). The one or more CCs may include a first CC and a second CC.

At 1204, the apparatus may receive, from the UE, at least one UL transmission based on at least one of the one or more Tx chains or the one or more antenna ports associated with a target switching case of the one of the plurality of switching cases, as described in connection with the examples in FIGS. 4A-9. For example, base station 904 may receive, from the UE, at least one UL transmission based on at least one of the one or more Tx chains or the one or more antenna ports associated with a target switching case of the one of the plurality of switching cases, as described in connection with 970 in FIG. 9. Further, 1204 may be performed by determination component 1440 in FIG. 14.

FIG. 13 is a diagram 1300 illustrating an example of a hardware implementation for an apparatus 1302. The apparatus 1302 may be a UE, a component of a UE, or may implement UE functionality. In some aspects, the apparatus 1302 may include a cellular baseband processor 1304 (also referred to as a modem) coupled to a cellular RF transceiver 1322. In some aspects, the apparatus 1302 may further include one or more subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, or a power supply 1318. The cellular baseband processor 1304 communicates through the cellular RF transceiver 1322 with the UE 104 and/or BS 102/180. The cellular baseband processor 1304 may include a computer-readable medium/memory. The computer-readable medium/memory may be non-transitory. The cellular baseband processor 1304 is responsible for general processing, including the execution of software stored on the computer-readable medium/memory. The software, when executed by the cellular baseband processor 1304, causes the cellular baseband processor 1304 to perform the various functions described supra. The computer-readable medium/memory may also be used for storing data that is manipulated by the cellular baseband processor 1304 when executing software. The cellular baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the cellular baseband processor 1304. The cellular baseband processor 1304 may be a component of the UE 350 and may include the memory 360 and/or at least one of the TX processor 368, the RX processor 356, and the controller/processor 359. In one configuration, the apparatus 1302 may be a modem chip and include just the baseband processor 1304, and in another configuration, the apparatus 1302 may be the entire UE (e.g., see 350 of FIG. 3) and include the aforediscussed additional modules of the apparatus 1302.

The communication manager 1332 includes a determination component 1340 that is configured to receive, from a base station, an indication of the UL Tx switching procedure, where the indication of the UL Tx switching procedure indicates the target switching case, e.g., as described in connection with step 1102 in FIG. 11. Determination component 1340 may be further configured to determine an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs), e.g., as described in connection with step 1104 in FIG. 11. Determination component 1340 may be further configured to switch, based on the determined UL Tx switching procedure, to the target switching case from one of the plurality of switching cases, e.g., as described in connection with step 1106 in FIG. 11. Determination component 1340 may be further configured to configure, based on the determined UL Tx switching procedure, at least one of the one or more Tx chains or the one or more antenna ports associated with a target switching case of the plurality of switching cases, e.g., as described in connection with step 1108 in FIG. 11. Determination component 1340 may be further configured to transmit, to a base station, at least one UL transmission based on the configured at least one of the one or more Tx chains or the one or more antenna ports associated with the target switching case, e.g., as described in connection with step 1110 in FIG. 11.

The apparatus may include additional components that perform each of the blocks of the algorithm in the aforementioned flowcharts of FIGS. 9, 10, and 11. As such, each block in the aforementioned flowcharts of FIGS. 9, 10, and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the cellular baseband processor 1304, includes means for receiving, from a base station, an indication of the UL Tx switching procedure, where the indication of the UL Tx switching procedure indicates the target switching case; means for determining an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs); means for switching, based on the determined UL Tx switching procedure, to the target switching case from one of the plurality of switching cases; means for configuring, based on the determined UL Tx switching procedure, at least one of the one or more Tx chains or the one or more antenna ports associated with a target switching case of the plurality of switching cases; and means for transmitting, to a base station, at least one UL transmission based on the configured at least one of the one or more Tx chains or the one or more antenna ports associated with the target switching case. The aforementioned means may be one or more of the aforementioned components of the apparatus 1302 configured to perform the functions recited by the aforementioned means. As described supra, the apparatus 1302 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 14 is a diagram 1400 illustrating an example of a hardware implementation for an apparatus 1402. The apparatus 1402 may be a base station, a component of a base station, or may implement base station functionality. In some aspects, the apparatus 1402 may include a baseband unit 1404. The baseband unit 1404 may communicate through a cellular RF transceiver 1422 with the UE 104. The baseband unit 1404 may include a computer-readable medium/memory. The baseband unit 1404 is responsible for general processing, including the execution of software stored on the computer-readable medium/memory. The software, when executed by the baseband unit 1404, causes the baseband unit 1404 to perform the various functions described supra. The computer-readable medium/memory may also be used for storing data that is manipulated by the baseband unit 1404 when executing software. The baseband unit 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the baseband unit 1404. The baseband unit 1404 may be a component of the base station 310 and may include the memory 376 and/or at least one of the TX processor 316, the RX processor 370, and the controller/processor 375.

The communication manager 1432 includes a determination component 1440 that is configured to transmit, to a user equipment (UE), an indication of an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs), e.g., as described in connection with step 1202 in FIG. 12. Determination component 1440 may be further configured to receive, from the UE, at least one UL transmission based on at least one of the one or more Tx chains or the one or more antenna ports associated with a target switching case of the one of the plurality of switching cases, e.g., as described in connection with step 1204 in FIG. 12.

The apparatus may include additional components that perform each of the blocks of the algorithm in the aforementioned flowcharts of FIGS. 9 and 12. As such, each block in the aforementioned flowcharts of FIGS. 9 and 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the baseband unit 1404, includes means for transmitting, to a user equipment (UE), an indication of an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs); and means for receiving, from the UE, at least one UL transmission based on at least one of the one or more Tx chains or the one or more antenna ports associated with a target switching case of the one of the plurality of switching cases. The aforementioned means may be one or more of the aforementioned components of the apparatus 1402 configured to perform the functions recited by the aforementioned means. As described supra, the apparatus 1402 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a user equipment (UE). The method includes determining an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs); configuring, based on the determined UL Tx switching procedure, at least one of the one or more Tx chains or the one or more antenna ports associated with a target switching case of the plurality of switching cases; and transmitting, to a base station, at least one UL transmission based on the configured at least one of the one or more Tx chains or the one or more antenna ports associated with the target switching case.

Aspect 2 is the method of aspect 1, further including receiving, from a base station, an indication of the UL Tx switching procedure, where the indication of the UL Tx switching procedure indicates the target switching case.

Aspect 3 is the method of any of aspects 1 and 2, where the indication of the UL Tx switching procedure is received via radio resource control (RRC) signaling.

Aspect 4 is the method of any of aspects 1 to 3, where the indication of the UL Tx switching procedure is associated with multiple component parts, each of the multiple component parts being associated with one of the plurality of switching cases.

Aspect 5 is the method of any of aspects 1 to 4, where the indication of the UL Tx switching procedure is associated with multiple component parts, each of the multiple component parts being associated with two of the plurality of switching cases.

Aspect 6 is the method of any of aspects 1 to 5, where the indication of the UL Tx switching procedure indicates that one of the one or more CCs is a priority CC.

Aspect 7 is the method of any of aspects 1 to 6, where the UL Tx switching procedure including the plurality of switching cases is predetermined, predefined, or preconfigured.

Aspect 8 is the method of any of aspects 1 to 7, where one of the plurality of switching cases is a priority switching case.

Aspect 9 is the method of any of aspects 1 to 8, where one CC of the one or more CCs is a primary component carrier (PCC) and another CC of the one or more CCs is a secondary component carrier (SCC), the one CC being a priority CC.

Aspect 10 is the method of any of aspects 1 to 9, where at least one of the plurality of switching cases is mapped to at least one of the one or more antenna ports, where the one or more antenna ports correspond to one or more antenna port combinations configured for each of the one or more CCs.

Aspect 11 is the method of any of aspects 1 to 10, where the plurality of switching cases is mapped to the one or more antenna ports based on a physical channel or signal of the at least one UL transmission, where the one or more antenna ports correspond to one or more antenna port combinations configured for each of the one or more CCs.

Aspect 12 is the method of any of aspects 1 to 11, where, if a first CC of the one or more CCs is associated with frequency division duplexing (FDD), the first CC is a priority CC, or where, if the first CC is associated with time division duplexing (TDD), the priority CC is one of the one or more CCs with a greater amount of UL transmissions.

Aspect 13 is the method of any of aspects 1 to 12, further including switching, based on the determined UL Tx switching procedure, to the target switching case from one of the plurality of switching cases.

Aspect 14 is the method of any of aspects 1 to 13, where the plurality of switching cases includes at least one of a first case (case 1), a second case (case 2), or a third case (case 3).

Aspect 15 is the method of any of aspects 1 to 14, where the one or more CCs include a first CC and a second CC.

Aspect 16 is an apparatus for wireless communication including at least one processor coupled to a memory and configured to implement a method as in any of aspects 1 to 15.

Aspect 17 is the method of aspect 16, further including a transceiver coupled to the at least one processor.

Aspect 18 is an apparatus for wireless communication including means for implementing a method as in any of aspects 1 to 15.

Aspect 19 is a computer-readable medium storing computer executable code, where the code when executed by a processor causes the processor to implement a method as in any of aspects 1 to 15.

Aspect 20 is a method of wireless communication at a base station. The method includes transmitting, to a user equipment (UE), an indication of an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs); and receiving, from the UE, at least one UL transmission based on at least one of the one or more Tx chains or the one or more antenna ports associated with a target switching case of the one of the plurality of switching cases.

Aspect 21 is the method of aspect 20, where the indication of the UL Tx switching procedure indicates the target switching case.

Aspect 22 is the method of any of aspects 20 and 21, where the indication of the UL Tx switching procedure is transmitted via radio resource control (RRC) signaling.

Aspect 23 is the method of any of aspects 20 to 22, where the indication of the UL Tx switching procedure is associated with multiple component parts, each of the multiple component parts being associated with one of the plurality of switching cases.

Aspect 24 is the method of any of aspects 20 to 23, where the indication of the UL Tx switching procedure is associated with multiple component parts, each of the multiple component parts being associated with two of the plurality of switching cases.

Aspect 25 is the method of any of aspects 20 to 24, where the indication of the UL Tx switching procedure indicates that one of the one or more CCs is a priority CC.

Aspect 26 is the method of any of aspects 20 to 25, where the UL Tx switching procedure including the plurality of switching cases is predetermined, predefined, or preconfigured.

Aspect 27 is the method of any of aspects 20 to 26, where one of the plurality of switching cases is a priority switching case.

Aspect 28 is the method of any of aspects 20 to 27, where one CC of the one or more CCs is a primary component carrier (PCC) and another CC of the one or more CCs is a secondary component carrier (SCC), the one CC being a priority CC.

Aspect 29 is the method of any of aspects 20 to 28, where at least one of the plurality of switching cases is mapped to at least one of the one or more antenna ports, where the one or more antenna ports correspond to one or more antenna port combinations configured for each of the one or more CCs.

Aspect 30 is the method of any of aspects 20 to 29, where the plurality of switching cases is mapped to the one or more antenna ports based on a physical channel or signal of the at least one UL transmission, where the one or more antenna ports correspond to one or more antenna port combinations configured for each of the one or more CCs.

Aspect 31 is the method of any of aspects 20 to 30, where, if a first CC of the one or more CCs is associated with frequency division duplexing (FDD), the first CC is a priority CC, or where, if the first CC is associated with time division duplexing (TDD), the priority CC is one of the one or more CCs with a greater amount of UL transmissions.

Aspect 32 is the method of any of aspects 20 to 31, where the plurality of switching cases includes at least one of a first case (case 1), a second case (case 2), or a third case (case 3).

Aspect 33 is the method of any of aspects 20 to 32, where the one or more CCs include a first CC and a second CC.

Aspect 34 is an apparatus for wireless communication including at least one processor coupled to a memory and configured to implement a method as in any of aspects 20 to 33.

Aspect 35 is the apparatus of aspect 34, further including a transceiver coupled to the at least one processor.

Aspect 36 is an apparatus for wireless communication including means for implementing a method as in any of aspects 20 to 33.

Aspect 37 is a computer-readable medium storing computer executable code, where the code when executed by a processor causes the processor to implement a method as in any of aspects 20 to 33.

1. An apparatus for wireless communication at a user equipment (UE), comprising:
a memory; and
at least one processor coupled to the memory and configured to:
determine an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs);
configure, based on the determined UL Tx switching procedure, at least one of the one or more Tx chains or the one or more antenna ports associated with a target switching case of the plurality of switching cases; and
transmit, to a base station, at least one UL transmission based on the configured at least one of the one or more Tx chains or the one or more antenna ports associated with the target switching case.

2. The apparatus of claim 1, wherein the at least one processor is further configured to:
receive, from a base station, an indication of the UL Tx switching procedure, wherein the indication of the UL Tx switching procedure indicates the target switching case.

3. The apparatus of claim 2, wherein the indication of the UL Tx switching procedure is received via radio resource control (RRC) signaling.

4. The apparatus of claim 2, wherein the indication of the UL Tx switching procedure is associated with multiple component parts, each of the multiple component parts being associated with one of the plurality of switching cases.

5. The apparatus of claim 2, wherein the indication of the UL Tx switching procedure is associated with multiple component parts, each of the multiple component parts being associated with two of the plurality of switching cases.

6. The apparatus of claim 2, wherein the indication of the UL Tx switching procedure indicates that one of the one or more CCs is a priority CC.

7. The apparatus of claim 1, wherein the UL Tx switching procedure including the plurality of switching cases is predetermined, predefined, or preconfigured.

8. The apparatus of claim 1, wherein one of the plurality of switching cases is a priority switching case.

9. The apparatus of claim 1, wherein one CC of the one or more CCs is a primary component carrier (PCC) and another CC of the one or more CCs is a secondary component carrier (SCC), the one CC being a priority CC.

10. The apparatus of claim 1, wherein at least one of the plurality of switching cases is mapped to at least one of the one or more antenna ports, wherein the one or more antenna ports correspond to one or more antenna port combinations configured for each of the one or more CCs.

11. The apparatus of claim 1, wherein the plurality of switching cases is mapped to the one or more antenna ports based on a physical channel or signal of the at least one UL transmission, wherein the one or more antenna ports correspond to one or more antenna port combinations configured for each of the one or more CCs.

12. The apparatus of claim 1, wherein, if a first CC of the one or more CCs is associated with frequency division duplexing (FDD), the first CC is a priority CC, or
wherein, if the first CC is associated with time division duplexing (TDD), the priority CC is one of the one or more CCs with a greater amount of UL transmissions.

13. The apparatus of claim 1, wherein the at least one processor is further configured to:
switch, based on the determined UL Tx switching procedure, to the target switching case from one of the plurality of switching cases.

14. The apparatus of claim 1, wherein the plurality of switching cases includes at least one of a first case (case 1), a second case (case 2), or a third case (case 3).

15. The apparatus of claim 1, wherein the one or more CCs include a first CC and a second CC.

16. The apparatus of claim 1, further comprising a transceiver coupled to the at least one processor.

17. A method of wireless communication at a user equipment (UE), comprising:
determining an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs);
configuring, based on the determined UL Tx switching procedure, at least one of the one or more Tx chains or the one or more antenna ports associated with a target switching case of the plurality of switching cases; and
transmitting, to a base station, at least one UL transmission based on the configured at least one of the one or more Tx chains or the one or more antenna ports associated with the target switching case.

18. An apparatus for wireless communication at a base station, comprising:
a memory; and
at least one processor coupled to the memory and configured to:
transmit, to a user equipment (UE), an indication of an uplink (UL) transmission (Tx) switching procedure including a plurality of switching cases, the UL Tx switching procedure associated with at least one of one or more Tx chains or one or more antenna ports, at least one of the one or more Tx chains or the one or more antenna ports corresponding to one or more component carriers (CCs); and
receive, from the UE, at least one UL transmission based on at least one of the one or more Tx chains or the one or more antenna ports associated with a target switching case of the one of the plurality of switching cases.

19. The apparatus of claim 18, wherein the indication of the UL Tx switching procedure indicates the target switching case, wherein the indication of the UL Tx switching procedure is transmitted via radio resource control (RRC) signaling.

20. The apparatus of claim 19, wherein the indication of the UL Tx switching procedure is associated with multiple component parts, each of the multiple component parts being associated with one or two of the plurality of switching cases.

21. The apparatus of claim 19, wherein the indication of the UL Tx switching procedure indicates that one of the one or more CCs is a priority CC.

22. The apparatus of claim 18, wherein the UL Tx switching procedure including the plurality of switching cases is predetermined, predefined, or preconfigured.

23. The apparatus of claim 18, wherein one of the plurality of switching cases is a priority switching case.

24. The apparatus of claim 18, wherein one CC of the one or more CCs is a primary component carrier (PCC) and another CC of the one or more CCs is a secondary component carrier (SCC), the one CC being a priority CC.

25. The apparatus of claim 18, wherein at least one of the plurality of switching cases is mapped to at least one of the one or more antenna ports based on a physical channel or signal of the at least one UL transmission, wherein the one or more antenna ports correspond to one or more antenna port combinations configured for each of the one or more CCs.

26. The apparatus of claim 18, wherein, if a first CC of the one or more CCs is associated with frequency division duplexing (FDD), the first CC is a priority CC, or wherein, if the first CC is associated with time division duplexing (TDD), the priority CC is one of the one or more CCs with a greater amount of UL transmissions.

27. The apparatus of claim 18, wherein the plurality of switching cases includes at least one of a first case (case 1), a second case (case 2), or a third case (case 3).

28. The apparatus of claim 18, wherein the one or more CCs include a first CC and a second CC.

29. The apparatus of claim 18, further comprising a transceiver coupled to the at least one processor.

30. (canceled)
